(19) United States
(12) Patent Application Publication
(10) Pub. No.: US 2008/0101852 A1
(43) Pub. Date: May 1, 2008

(54) Holepunch for a ringed binder

(76) Inventor: Mark A. Bedol, Claremont, CA (US)

Correspondence Address: LAWRENCE N. GINSBERG, 21 SAN ANTONIO, NEWPORT BEACH, CA, 92660-9112, US

(21) Appl. No.: 11/589,574

(22) Filed: Oct. 30, 2006

(51) Int. Cl. B42F 13/00

(52) U.S. Cl. 402/79

(57) ABSTRACT

A notebook insert that includes a housing including a first rigid substantially flat plate having a first set of a plurality of spaced holes formed therethrough a first side thereof. The first set of holes is adapted for engagement with the rings of a ringed notebook. The first rigid flat plate further has a second set of a plurality of spaced, stepped holes formed therethrough a second side thereof. The housing further includes an opening in a central portion thereof and a plurality of spaced hinges. The hinges are located on a side edge of the central portion defined by the opening. A second rigid plate has a first side hingedly connected via the spaced hinges to the first rigid plate. The second plate has a shape substantially matching the shape of the central opening so when the second rigid plate is in a stowed position it may be supported within the central opening. The second plate includes spaced projections formed on an upper surface thereof. The projections are so sized and spaced to align with the second set of spaced holes in the first plate when the second plate is rotated away from the stowed position so as to provide a holepunching capability when paper is inserted between an upper surface of the first plate and the second plate. The stepped holes have increased diameters at lower surfaces thereof that allow chads to be cleanly and easily be punched therethrough and released from the stepped holes when the second rigid plate is rotated away after punching paper. The stepped holes provide enhanced ease in disengaging the second rigid plate from the first rigid plate when rotating it back into position.

### BACKGROUND OF THE INVENTION

1. Field of the Invention

The present invention relates to inserts for notebooks and more particularly to a notebook insert which is securable to the rings of a notebook and has a holepunch mechanism which is capable of punching paper while remaining attached to the rings of the ringed binder.

2. Description of the Related Art

Users of notebooks, including businessmen and students, often desire to have various articles such as pencils and pens at their easy disposal when they use their notebook and to be secure from being lost when they carry their notebooks from one location to another.

In partial solution to this problem, present applicant Mark A. Bedol, invented a “Notebook Organizer Including Slidable Element”, U.S. Pat. No. 5,050,736. The '736 patent discloses an organizer comprising a base with holes for engagement with the rings of a ringed notebook. The base includes a plurality of partitions which divide the base into a plurality of compartments. The patent also discloses an electronic calculator having a longitudinal extension thereon being slidably engageable with, and supported between, opposing partition surfaces.

Present applicant Mark A. Bedol, has also invented “Notebook Insert With Calculator and Holepunch” U.S. Pat. No. 5,209,592, which discloses a notebook insert comprising a housing, an electronic calculator attached to the housing and a holepunch assembly also attached to the housing. The housing has a periphery with multiple holes therethrough which are spaced to be adapted for engagement with the rings of a ringed notebook.

McGill, Inc. of Maringo, Ill., discloses a three-hole binder punch which is insertable into the rings of a ringed binder. This binder punch involves two pieces. A first piece inserts through the rings of the binder and a second piece, the holepunch mechanism, snaps into place on the first piece.

McGill also manufactures another three-hole paper punch under the trademark Trident. The Trident holepunch includes a plastic base with a metal hinge mechanism attached along the top surface thereof.

U.S. Pat. No. 5,409,319, also invented by applicant Mark A. Bedol, entitled, “Notebook Insert with Holepunch,” discloses a notebook insert with a housing having a first rigid substantially flat plate having a first set of a number of spaced holes formed therethrough a first side thereof, the first set of holes being adapted for engagement with the rings of a ringed notebook. The housing further has a second set of a number of spaced holes formed therethrough a second side thereof. The housing further includes an opening in a central portion thereof. A number of spaced hinges are located on a side edge of the central portion defined by the opening. A second rigid plate has a first side hingedly connected via the spaced hinges to the first rigid plate. The second plate has a shape substantially matching the shape of the central opening so when the second rigid plate is in a stowed position it may be supported within the central opening. The second plate includes spaced projections formed on an upper surface thereof. The projections are so sized and spaced to align with the second set of spaced holes in the first plate when the second plate is rotated away from the stowed position so as to provide a holepunching capability when paper is inserted between the first plate and the second plate. Thus, the holepunch capability may be utilized without a need for removing the notebook insert from a binder it may be attached to.

U.S. Pat. No. Des. 354,770, entitled “Hole Punch for a Ring-Binder,” also by invented by applicant Bedol discloses a hole punch for a ring binder.

The Bedol related disclosed hole punches provide an efficient, inexpensive means for simultaneously minimizing the space taken in a notebook binder and being capable of punching paper while remaining attached to the rings of the binder.

### SUMMARY OF THE INVENTION

In a broad aspect, the present invention is a notebook insert that includes a housing including a first rigid substantially flat plate having a first set of a plurality of spaced holes formed therethrough a first side thereof. The first set of holes is adapted for engagement with the rings of a ringed notebook. The first rigid flat plate further has a second set of a plurality of spaced, stepped holes formed therethrough a second side thereof. The housing further includes an opening in a central portion thereof and a plurality of spaced hinges. The hinges are located on a side edge of the central portion defined by the opening. A second rigid plate has a first side hingedly connected via the spaced hinges to the first rigid plate. The second plate has a shape substantially matching the shape of the central opening so when the second rigid plate is in a stowed position it may be supported within the central opening. The second plate includes spaced projections formed on an upper surface thereof. The projections are so sized and spaced to align with the second set of spaced holes in the first plate when the second plate is rotated away from the stowed position so as to provide a holepunching capability when paper is inserted between an upper surface of the first plate and the second plate. The stepped holes have increased diameters at lower surfaces thereof that allow chads to be cleanly and easily be punched therethrough and released from the stepped holes when the second rigid plate is rotated away after punching paper. The stepped holes provide enhanced ease in disengaging the second rigid plate from the first rigid plate when rotating it back into position. The holepunching capability may be utilized without a need for removing the notebook insert from a binder it may be attached to.

The challenge in the design of this holepunch has been to compromise making the projections more tightly engageble with the holes that they are inserted within (thus providing a cleaner punch of the paper) while still being able to disengage the projections with sufficient ease. This stepped design allows the projections to more effectively punch yet allow easy release.

The upper surfaces of the projections each have a central recessed portion and two peak portions ascending from the central recessed portion. These projections are shaped as such to provide enhanced engagement of plates during operation.

### BRIEF DESCRIPTION OF THE DRAWINGS

FIG. 1 is a perspective view of the notebook insert of the present invention.

FIG. 2 is bottom view of the notebook insert.

FIG. 3 is a side view of the notebook insert, partially in cross-section, taken along line 3-3 of FIG. 1.

FIG. 4 is a bottom end view of the notebook insert, showing the working motion of the holepunch plate rotating to punch paper.

FIG. 5 is a side view of the notebook insert, partially in cross-section, taken along line 5-5 of FIG. 1.

FIG. 6 is a top view of the bottom portion of the notebook insert.

### DETAILED DESCRIPTION OF THE INVENTION

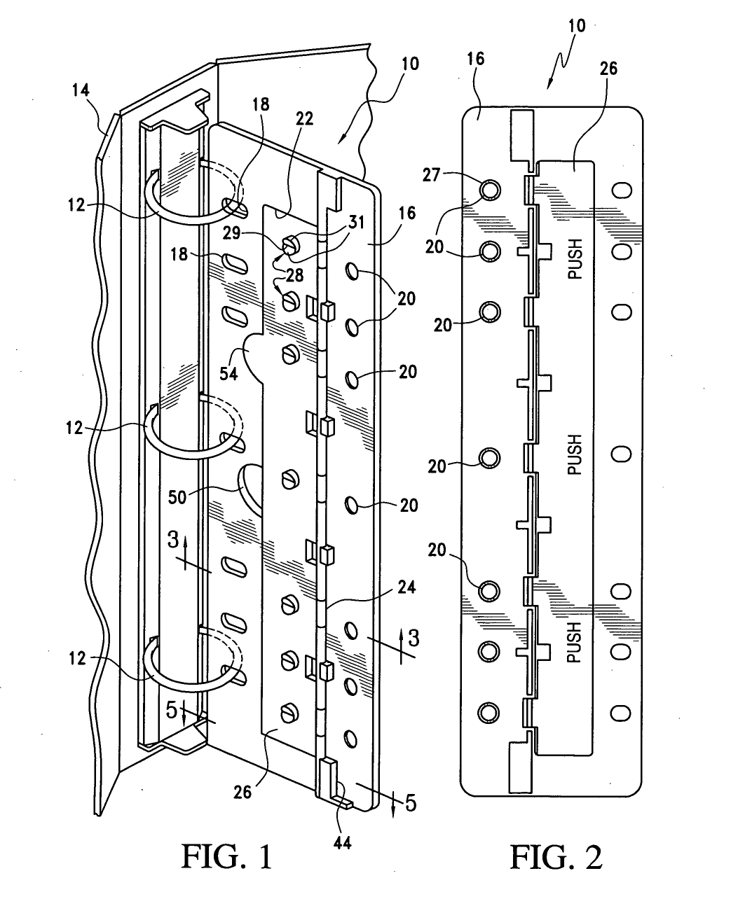

Referring to the drawings and the characters of reference marked thereon, FIG. 1 illustrates the notebook insert of the present invention, designated generally as 10 shown attached to the rings 12 of a conventional ringed binder, designated generally as 14. Notebook insert 10 includes a housing 16 which comprises a first rigid, substantially flat plate. Housing or first plate 16 has a first set of a plurality of spaced holes 18 formed therethrough along a first side thereof. This first set of holes 18 are spaced and sized for engagement with the rings 12 of the ringed notebook 14, as shown. The housing (or first plate) 16 further includes a second set of a plurality of spaced holes 20 formed on a second side of the housing 16. The housing 16 further includes an opening 22 in a central portion thereof. A plurality of spaced hinges 24 are located on a side edge of the side portion defined by the opening 22.

A second rigid plate 26 has a first side hingedly connected via the spaced hinges 24 to the first rigid plate 16. The second plate 26 has a shape substantially matching the shape of the central opening 22 so that when the second rigid plate 26 is in the stowed position illustrated in FIG. 1 it may be supported within the central opening 22.

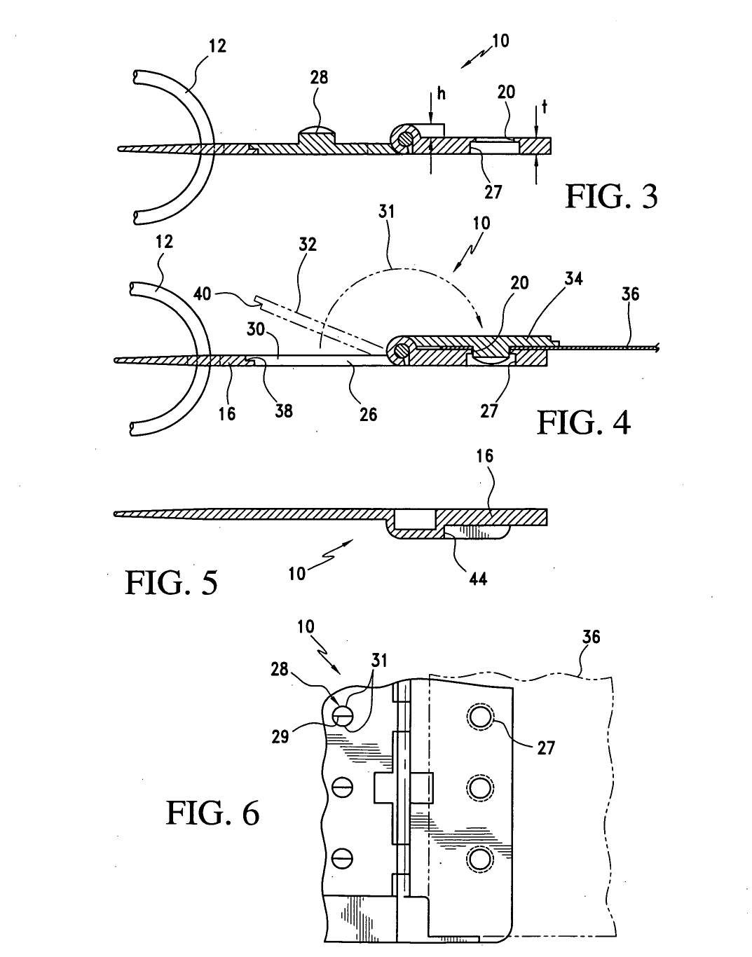

Second plate 26 includes spaced projections 28 formed on an upper surface thereof (see also FIG. 3). The projections 28 are sized and spaced so as to align with the second set of spaced holes 20 in the first plate 16 when the second plate 26 is rotated away from the stowed position. Thus, a holepunching capability is provided when paper is inserted between the two plates 16, 26. The upper surfaces of the projections 28 each have a central recessed portion 29 and two peak portions 31 ascending from the central recessed portion 29. These projections 28 are shaped as such to provide enhanced engagement of plates 16 and 26 during operation. The shape of the projections 28 provide engagement of paper where the edges of the hole on the first plate 16 are located and push, which tends to stretch the paper.

As can be seen in FIG. 2, the second set of spaced holes 20 in the first plate 16 are stepped holes. The stepped holes 20 have an increased diameter at a lower surface 27 thereof.

FIG. 4 illustrates a sequence of operations illustrating use of this invention. In the stowed position 30 the second plate 26 rests flush with the first plate 16. As the plate 26 rotates in the direction of arrow 31 it goes through an intermediate position 32 and then finally to position 34 where it cuts holes in paper 36. The notebook insert 10 of the present invention a unique capability of being utilized without a need for removing the notebook insert from the binder 14 which it is attached to.

The stepped holes 20, by having increased diameters at lower surfaces thereof allow chads to be cleanly and easily be punched therethrough and released from the stepped holes 20 when the second rigid plate 32 is rotated away after punching paper 36. Furthermore, the stepped holes 20 provide enhanced ease in disengaging the second rigid plate 32 from the first rigid plate 16 when rotating it back into position because engaging surface areas are minimized.

Referring to FIGS. 3 and 5 it can be seen that the first and second plates 16, 26 each have substantially the same thickness t. Furthermore, the projections 28 and hinges 24 have substantially the same height, h. Therefore, when the notebook insert 10 is in a stowed position it has a maximum height of t plus h, thereby minimizing the maximum thickness of the notebook insert 10. (Thickness t is preferably approximately equal to height h.) The total height (h plus t) of the notebook insert 10 is approximately between 2/32 inches and ½ inch. The insert 10 is preferably formed of plastic material; however, it may be formed of metal or a glass or metal filled plastic.

A second side edge of the central portion formed by central opening 22 has a recessed portion 38 on an upper surface thereof. The second rigid plate 26 has a second side with a recessed portion 40 formed on a lower surface thereof. Recesses 38 and 40 match so that when the notebook insert 10 is in a stowed position the upper surface of the second plate 26 is maintained substantially flush with the unrecessed remaining portions of the upper surface first plate 16.

Tab 54 and opening 50 provide convenient opening and closing of the second plate 26.

Referring now to FIG. 6 can be seen that notebook insert 10 preferably also includes spaced paper positioning projections 44 for assuring that the paper is maintained in the proper position for hole punching.

Other embodiments and configurations may be devised without departing from the spirit of the invention and the scope of the appended claims.

1. A notebook insert, comprising:
a) a housing comprising a first rigid substantially flat plate having a first set of a plurality of spaced holes formed therethrough a first side thereof, said first set of holes being adapted for engagement with the rings of a ringed notebook, said first rigid flat plate further having a second set of a plurality of spaced stepped holes formed therethrough a second side thereof;
said housing further including an opening in a central portion thereof, and,
a plurality of spaced hinges, said hinges being located on a side edge of said central portion defined by said opening; and,
b) a second rigid plate having a first side hingedly connected via said spaced hinges to said first rigid plate, said second plate having a shape substantially matching the shape of said central opening so when said second rigid plate is in a stowed position it may be supported within said central opening, said second plate including spaced projections formed on an upper surface thereof, said projections being so sized and spaced to align with said second set of spaced holes in said first plate when said second plate is rotated away from said stowed position so as to provide a holepunching capability when paper is inserted between an upper surface of said first plate and said second plate, said stepped holes having increased diameters at lower surfaces thereof allow chads to be cleanly and easily be punched therethrough and released from said stepped holes when said second rigid plate is rotated away after punching paper, said stepped holes providing enhanced ease in disengaging said second rigid plate from said first rigid plate when rotating it back into position, and wherein said holepunch capability may be utilized without a need for removing the notebook insert from a binder it may be attached to.

2. The notebook insert of claim 1, wherein said stepped holes comprise a single step.

3. The notebook insert of claim 1, wherein said spaced projections each comprise an upper surface having a central recessed portion and two peak portions ascending from said central recessed portion so as to provide enhanced engagement of said first and second rigid plates during operation.

4. The notebook insert of claim 1 wherein said first plate has a second side edge of said central portion opposite said first side edge, said second edge having a recessed portion on an upper surface thereof; and, said second rigid plate has a second side with a recessed portion formed on a lower surface thereof, the recessed portion on said first plate matching the recessed portion on said second plate so that when said notebook insert is in a stowed position an upper surface of said second plate is maintained substantially flush with the unrecessed portions of the upper surface of said first plate.

5. The notebook insert of claim 1, wherein said hinges provide 180 degree rotation of said second plate relative to said first plate thereby minimizing the total thickness of said apparatus.
